(19) United States
(12) Patent Application Publication
(10) Pub. No.: US 2012/0133783 A1
(43) Pub. Date: May 31, 2012

(54) IMAGE DISPLAY APPARATUS, IMAGE DISPLAY SYSTEM, IMAGE DISPLAY METHOD, AND PROGRAM

(76) Inventor: Takashi EGASHIRA, Tokyo (JP)

(21) Appl. No.: 13/301,930

(22) Filed: Nov. 22, 2011

(30) Foreign Application Priority Data
Nov. 29, 2010 (JP) P2010-265650

(51) Int. Cl. H04N 5/225

(52) U.S. Cl. 348/207.1; 348/E05.024

(57) ABSTRACT

An image display apparatus includes: a receiving portion; a buffer; a buffer control portion; a display portion; and a display control portion.

### BACKGROUND

The present disclosure relates to an image display apparatus, an image display system, an image display method, and a program.

Heretofore, there has been known an image display system in which image information is delivered from a camera through a transmission path such as an IP network and is received by an image display apparatus, and an image corresponding to the image information is displayed on the display device. Either a camera or a camera server delivers the image information with a predetermined delivery period through the transmission path. The image display apparatus receives the image information through the transmission path, accumulates the image information thus received in a buffer, and displays thereon the image corresponding to the image information at a predetermined timing.

However, when a change in transmission rate in the transmission path exceeds the range of an ability of the buffer of the image display apparatus, it may be impossible to display the image corresponding to the image information at a predetermined timing. As a result, it may be impossible to smoothly display the image corresponding to the image information, and thus an image quality is reduced. For this reason, for example, Japanese Patent Laid-Open No. Hei 11-187383 discloses an image display technique constructed in such a way that a data rate of image information is changed depending on a change in communication situation of a transmission path.

### SUMMARY

However, the image display technique disclosed in Japanese Patent Laid-Open No. Hei 11-187383 requires data conversion processing corresponding to the change in data rate. In addition, when the communication situation of the transmission path is reduced, the data rate of the image information is reduced, and thus the image quality is reduced.

The present disclosure has been made in order to solve the problems described above, and it is therefore desirable to provide an image display apparatus, an image display system, an image display method, and a program which can suppress reduction of an image quality due to a change in communication situation of a transmission path.

In order to attain the desire described above, according to an embodiment of the present disclosure, there is provided an image display apparatus. The image display apparatus includes: a receiving portion configured to receive image information delivered from a camera through a transmission path; a buffer configured to accumulate therein the image information thus received; a buffer control portion configured to write the image information thus received to the buffer, and read out the image information in an order of writing from the buffer; and a display portion configured to repetitively display thereon an image corresponding to the image information thus read out with one or more display periods set in accordance with a relationship between a delivery period and a display period of the image information. The image display apparatus further includes a display control portion configured to increase the number of times of the display period with which the image corresponding to the image information is repetitively displayed when a reception interval of the image information is longer than the delivery period of the image information depending on a communication situation of the transmission path and decrease the number of times of the display period with which the image corresponding to the image information is repetitively displayed when the reception interval of the image information is shorter than the delivery period of the image information depending on the communication situation of the transmission path.

According to another embodiment of the present disclosure, there is provided an image display system. The image display system includes: a camera; and an image display apparatus connected to the camera through a transmission path. The image display apparatus includes: a receiving portion configured to receive image information delivered from a camera through a transmission path; a buffer configured to accumulate therein the image information thus received; and a buffer control portion configured to write the image information thus received to the buffer, and read out the image information in an order of writing from the buffer; and a display portion configured to repetitively display thereon an image corresponding to the image information thus read out with one or more display periods set in accordance with a relationship between a delivery period and a display period of the image information. The image display apparatus further includes a display control portion configured to increase the number of times of the display period with which the image corresponding to the image information is repetitively displayed when a reception interval of the image information is longer than the delivery period of the image information depending on a communication situation of the transmission path and decrease the number of times of the display period with which the image corresponding to the image information is repetitively displayed when the reception interval of the image information is shorter than the delivery period of the image information depending on the communication situation of the transmission path.

According to still another embodiment of the present disclosure, there is provided an image display method including: receiving image information delivered from a camera through a transmission path; accumulating the image information thus received in a buffer; writing the image information thus received to the buffer, and reading out the image information in an order of writing from the buffer; and repetitively displaying an image corresponding to the image information thus read out with one or more display periods set in accordance with a relationship between a delivery period and a display period of the image information. The image display method further including increasing the number of times of the display period with which the image corresponding to the image information is repetitively displayed when a reception interval of the image information is longer than the delivery period of the image information depending on a communication situation of the transmission path and decreasing the number of times of the display period with which the image corresponding to the image information is repetitively displayed when the reception interval of the image information is shorter than the delivery period depending on the communication situation of the transmission path.

According to yet another embodiment of the present disclosure, there is provided a program causing a computer to execute an image display method including: receiving image information delivered from a camera through a transmission path; accumulating the image information thus received in a buffer; writing the image information thus received to the buffer, and reading out the image information in an order of writing from the buffer; repetitively displaying an image corresponding to the image information thus read out with one or more display periods set in accordance with a relationship between a delivery period and a display period of the image information; and increasing the number of times of the display period with which the image corresponding to the image information is repetitively displayed when a reception interval of the image information is longer than the delivery period of the image information depending on a communication situation of the transmission path and decreasing the number of times of the display period with which the image corresponding to the image information is repetitively displayed when the reception interval of the image information is shorter than the delivery period depending on the communication situation of the transmission path. In this case, the program either may be provided by using a computer readable recording medium or may be provided through a communication section or the like.

As set forth hereinabove, according to the present disclosure, it is possible to provide the image display apparatus, the image display system, the image display method, and the program which can suppress the reduction of the image quality due to the change in communication situation of the transmission path.

### BRIEF DESCRIPTION OF THE DRAWINGS

FIG. 1 is a schematic view showing an entire configuration of an image display system according to an embodiment of the present disclosure;

FIG. 2 is a block diagram showing a functional configuration of the image display system according to the embodiment of the present disclosure;

FIG. 3 is a flow chart showing an operation of an image display apparatus in the image display system according to the embodiment of the present disclosure;

FIG. 4 is a diagram showing control for writing image information;

FIG. 5 is a diagram showing control for displaying the image information;

FIG. 6 is a diagram showing a method of adjusting the number of times of display of an image corresponding to the image information;

FIG. 7 is another diagram showing the method of adjusting the number of times of the display of the image corresponding to the image information; and

FIG. 8 is a further diagram showing the method of adjusting the number of times of the display of the image corresponding to the image information.

### DETAILED DESCRIPTION OF THE PREFERRED EMBODIMENTS

Embodiments of the present disclosure will be described in detail hereinafter with reference to the accompanying drawings. It is noted that in this specification and the drawings, constituent elements which have substantially the same functional constitutions are designated by the same reference numerals or symbols, respectively, and thus a repeated description thereof is omitted for the sake of simplicity.

### 1. Configuration of Image Display System

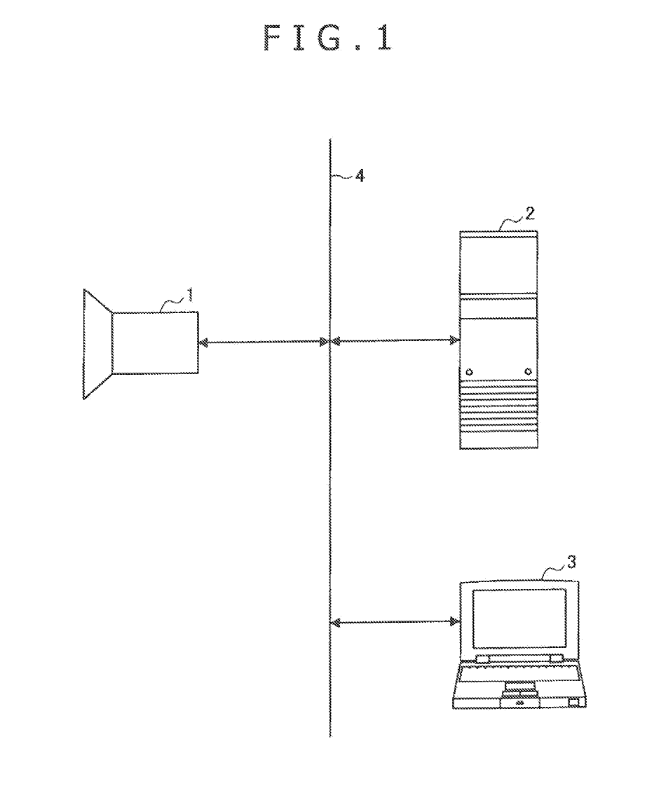

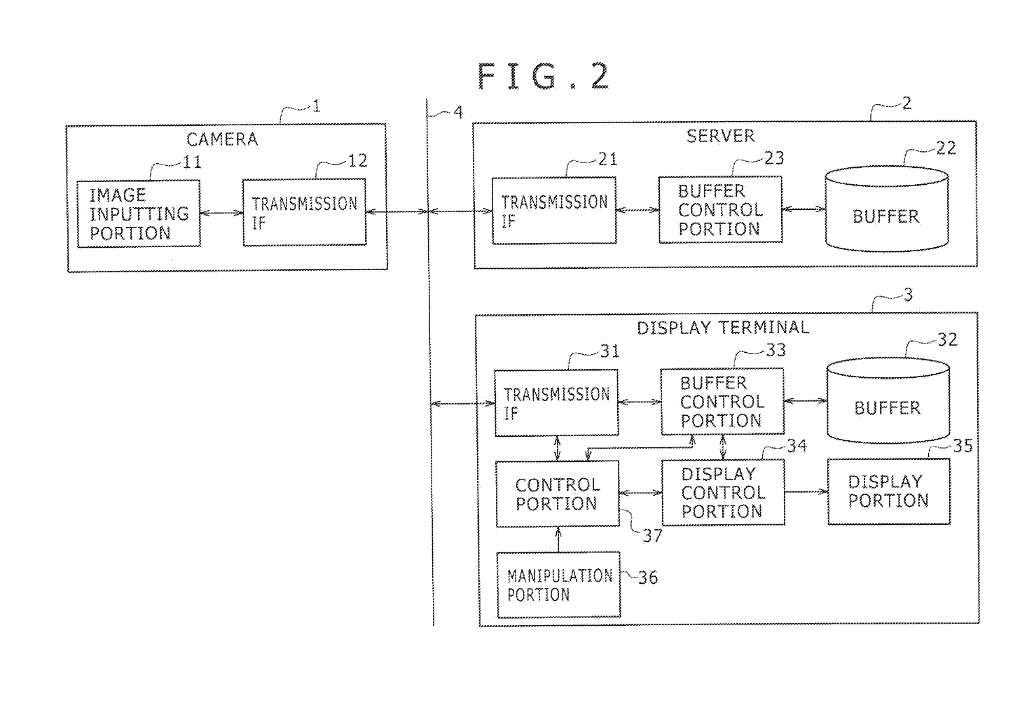

Firstly, an image display system according to an embodiment of the present disclosure will be described in detail with reference to FIGS. 1 and 2.

FIG. 1 is a schematic view showing an entire configuration of the image display system according to the embodiment of the present disclosure. As shown in FIG. 1, the image display system includes a camera 1, a server 2 connected to the camera 1 through a transmission path 4, and a display terminal 3 connected to the server 2 through the transmission path 4. The camera 1 is a network camera such as an IP camera, and the server 2 is a camera server or the like. The display terminal 3 is an image display apparatus such as a personal computer, a personal digital assistance, a mobile phone, or a network television. Also, the transmission path 4 is a wired or wireless communication line such as an IP network, a LAN, or a WAN.

FIG. 2 is a block diagram showing a functional configuration of the image display system according to the embodiment of the present disclosure. As shown in FIG. 2, the camera 1 includes an image inputting portion 11 and a transmission interface (IF) 12. In this case, the image inputting portion 11 carries out an image capturing operation with a predetermined image capturing period, thereby generating image information. Also, the transmission IF 12 compresses the image information and transmits the resulting image information to the sever 2 through the transmission path 4. The camera 1 may be constructed so as to be capable of carrying out a pan, tilt or zooming operation depending on manipulation information sent thereto from the display terminal 3.

The server 2 includes a transmission IF 21, a buffer 22, and a buffer control portion 23. The transmission IF 21 receives the image information sent thereto from the camera 1, and receives the control information sent thereto from the display terminal 3. Also, the transmission IF 21 delivers the image information to the display terminal 3 with a predetermined delivery period in accordance with a request made from the display terminal 3. The buffer 22, for example, is an FIFO memory for temporarily accumulating therein the image information in order to absorb a change in transmission rate in the transmission path 4 between the camera 1 and the server 2. The buffer control portion 23 writes the image information received from the camera 1 to the buffer 22, reads out the image information which is to be delivered to the display terminal 3 from the buffer 22, and supplies the image information thus read out to the transmission IF 21. It is noted that the server 2 may also be provided integrally with the camera 1.

The display terminal 3 includes a transmission IF (receiving portion) 31, a buffer 32, a buffer control portion 33, a display control portion 34, a display portion 35, a manipulation portion 36, and a control portion 37. The transmission IF 31 receives and expands the image information sent thereto from the server 2, and supplies the resulting image information to the buffer 32. Also, the transmission IF 31 transmits the control information sent thereto from the control portion 37 to the server 2. The buffer 32, for example, is an FIFO memory for temporarily accumulating therein the image information in order to absorb a change in transmission rate in the transmission path 4 between the server 2 and the display terminal 3. The manipulation portion 36 supplies the manipulation information inputted through a manipulation made by a user to the control portion 37. The control portion 37 executes arithmetic operation processing and control processing for realizing the operation of the display terminal 3.

The buffer control portion 33 writes the image information received by the transmission IF 31 to the buffer 32, reads out the image information which is to be delivered in the order of the writing from the buffer 32, and supplies the image information thus read out to the display control portion 34. The display portion 35 is constructed in the form of a display device such as a liquid crystal display device or an organic EL display device. The display portion 35 may also be constructed in the form of an external device of the display terminal 3. The display portion 35 repetitively displays thereon an image corresponding to the image information thus read out with one or more display periods set in accordance with a relationship between a delivery period and a display period of the image information. It is noted that the relationship between the delivery period and display period of the image information will be described later. The display control portion 34 increases the number (the number, Nd, of times of display) of times of the display period with which the image corresponding to the image information is repetitively displayed when a reception interval of the image information becomes longer than the delivery period, and decreases the number (the number, Nd, of times of display) of times of the display period with which the image corresponding to the image information is repetitively displayed when the reception interval of the image information becomes shorter than the delivery period in accordance with a communication situation of the transmission path 4.

Here, the buffer control portion 33, the display control portion 34, and the control portion 37 are configured in the form of a hardware logic and/or software. When the buffer control portion 33, the display control portion 34, and the control portion 37 are configured in the form of the software, a CPU of the display terminal 3 develops in a RAM or the like a program stored in a ROM or the like to execute the program, thereby executing the arithmetic operation processing and control processing for realizing an image displaying method which will be described later.

### 2. Operation of Image Display System

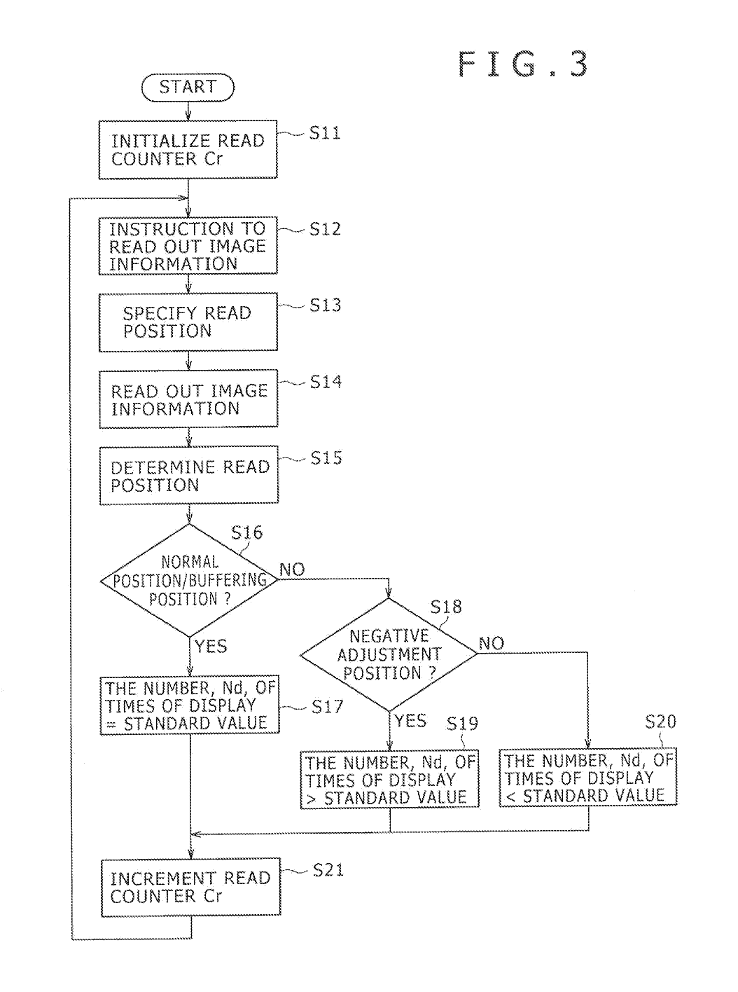

Next, an operation of the image display apparatus (the display terminal 3) in the image display system according to the embodiment of the present disclosure will be described with reference to FIGS. 3 to 8.

In the following description, there is supposed the case where the delivery period of the image information by the server 2 is set to 1/30 seconds (30 frames/second), and the display period of the image information in the display terminal 3 is set to 1/60 seconds (a vertical period Vsync=60 Hz). In this case, if the interval of the reception of the image information by the display terminal 3 agrees with the delivery period, the image corresponding to the same image information is repetitively displayed with the continuous two display periods. However, an actual interval of the reception (an interval of writing of the image information to the buffer 32) agrees with the delivery period, or becomes longer or shorter than the delivery period in accordance with the communication situation of the transmission path 4. It should be noted that the values of the delivery period and display period described above are merely an example, and thus the image may be displayed with any other suitable period.

FIG. 3 is a flow chart showing the operation of the image display apparatus in the image display system according to the embodiment of the present disclosure. In the server 2, the image information which is transmitted every image capturing period is received from the camera 1, and the image information thus received is accumulated in the buffer 22.

When in the display terminal 3, a request to start the image display is made from the user through the manipulation portion 36, the control portion 37 requests the server 2 to start of delivery of the image information through the transmission IF 31. In response to the request, the transmission IF 31 successively receives the image information which has been delivered from the server 2. A sequence representing the display order or reception order of the image information such as the image information 1, 2, . . . is contained in the image information. In response to the reception of the image information by the transmission IF 31, the buffer control portion 33 successively writes the image information to the buffer 32 in the manner as will be described below.

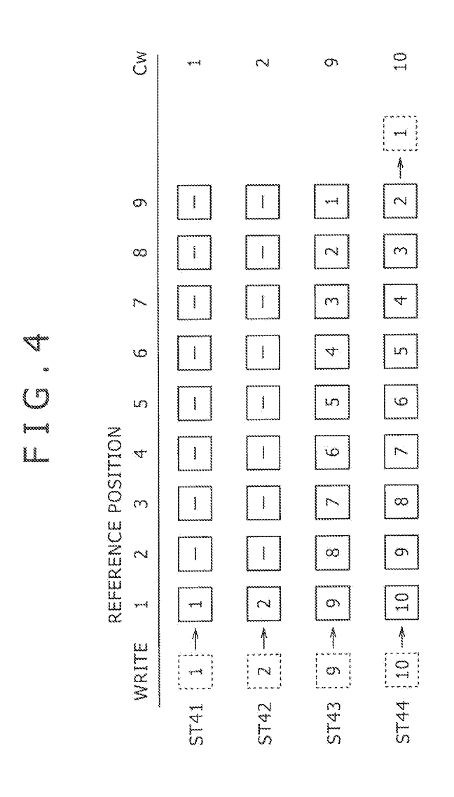

FIG. 4 is a diagram showing control for writing the image information. As shown in FIG. 4, the buffer control portion 33 writes the image information to the buffer 32 in a First-in First-out manner. In the following description, for the purpose of describing the operation of the display terminal 3 in an easy-to-understood format, it is supposed that the buffer 32 can accumulate therein up to nine pieces of image information in reference positions 1 to 9, respectively.

Firstly, when the image information 1 is received in a state in which the buffer 32 is empty, the image information 1 is written to a reference position 1 (a state ST41). When the image information 2 is received, the image information 1 is moved from the reference position 1 to a reference position 2, and thus the image information 2 is written to the image information 1 (a state ST42). Likewise, when seven pieces of image information 3 to 9 are successively received, the nine pieces of image information are accumulated in the order to the image information 9 to 1 in reference positions 1 to 9, respectively (a state ST43). Also, when the image information 10 is received, the image information 1 which has been accumulated in the reference position 9 is deleted from the buffer 32, and the nine pieces of image information are accumulated in the order of the nine pieces of image information 10 to 2 in the reference positions 1 to 9, respectively (a state ST44).

In addition, the buffer control portion 33 manages a sequence (image number) of the image information newly written by using a write counter Cw. The write counter Cw is set in such a way that Cw=1 in the state ST41, Cw=2 in the state ST42, Cw=9 in the state ST43, and Cw=10 in the state ST44.

When the buffer 32 becomes full with the image information as with the state ST43 shown in FIG. 4, the buffer control portion 33 informs the control portion 37 of completion of a buffer preparation. The control portion 37 instructs the display control portion 34 to start to display the image.

When the display control portion 34 is instructed to start to display the image, as shown in FIG. 3, the display control portion 34 initializes a read counter Cr (Step S11). The read counter Cr is initialized with the sequence of the image information accumulated in a specific reference position of the buffer 32. In order that the buffer 32 may flexibly cope with a change in communication situation of the transmission path 4, for example, a central position of the buffer 32, in a word, the reference position 5 is set as the specific reference position. In this case, the sequence of the image information 5 accumulated in the reference position 5 is specified as Cr=5 by the read counter Cr. It is noted that the specific reference position may also be set to any other suitable position other than the central position of the buffer 32.

In addition, for the purpose of controlling the image display in accordance with the change in communication situation of the transmission path 4, the specific reference position is set as a normal position, and the reference position in the vicinity of the normal position is set as a buffering position. In addition, the reference position on the front side (on the side of the smaller number of the reference position) relative to the buffering position is set as a negative adjustment position. Also, the reference position on the rear side (on the side of the larger number of the reference position) relative to the buffering position is set as a positive adjustment position. For example, when the specific position is the reference position 5, the reference position 5 is set as the normal position, each of the reference positions 4 and 6 is set as the buffering position, each of the reference positions 1 to 3 is set as the negative adjustment position, and each of the reference positions 7 to 9 is set as the positive adjustment position. It is noted that the buffering position may not be set, and only one of the positive adjustment position or the negative adjustment position may also be set. In addition, the number of reference positions which are set as the buffering position, and the positive or negative adjustment position is by no means limited to the example described above.

The display control portion 34 instructs the buffer control portion 33 to read out the image information by using the read counter Cr (Step S12). In this case, the buffer control portion 33 is instructed to read out the image information 5 specified by the read counter Cr=5.

In response to the read instruction, the buffer control portion 33 specifies the read position for the image information by using the write counter Cw and the read counter Cr (Step S13). In this case, since the contents of the write counter Cw are Cw=9, the image information 9 is accumulated in the reference position 9. Also, since the contents of the read counter Cr are Cr=5, the read position for the image information 5 is specified as the reference position 5. In a word, in this case, the read position for the image information 5 is specified as (Cw−Cr+1) by using the write counter Cw and the read counter Cr.

The buffer control portion 33 read out the image information from the specified reference position (Step S14), and supplies the image information thus read out together with information representing a kind of read position to the display control portion 34. In this case, the information representing that the read position is the reference position 5, in a word, a normal position is supplied together with the image information 5 to the display control portion 34.

When the display control portion 34 has received the image information, for the purpose of setting the number, Nd, of times of the display of the image corresponding to the image information, the display control portion 34 determines the read position depending on the kind of read position (Step S15). The number, Nd, of times of the display of the image corresponding to the image information is set in the display control portion 34 as follows. It is noted that instead of the information representing the kind of read position, the display control portion 34 may also receive the write counter Cw from the buffer control portion 33, thereby determining a kind of read position by using the write counter Cw and the read counter Cr.

When the kind of read position represents either the normal position or the buffering position (Step S16), it is determined that the interval of the reception of the image information agrees with the period of delivery of the image information, or a difference between the interval of the reception and the period of delivery is smaller than a threshold value. Therefore, the number, Nd, of times of the display of the image corresponding to the image information is set as the standard value Nd=2 in accordance with a relationship between the period (1/30 seconds) of the delivery of the image information, and the period (1/60 seconds) of the display of the image corresponding to the image information (Step S17).

On the other hand, when the kind of read position represents the negative adjustment portion (Step S18), it is determined that the interval of the reception of the image information is longer than the period of the delivery of the image information. Therefore, the number, Nd, of times of the display of the image corresponding to the image information is set as the number of times larger than the standard value, for example, as Nd=3 (Step S19). Likewise, when the kind of read position represents the positive adjustment portion, it is determined that the interval of the reception of the image information is shorter than the period of the delivery of the image information. Therefore, the number, Nd, of times of the display of the image corresponding to the image information is set as the number of times smaller than the standard value, for example, as Nd=1 (Step S20).

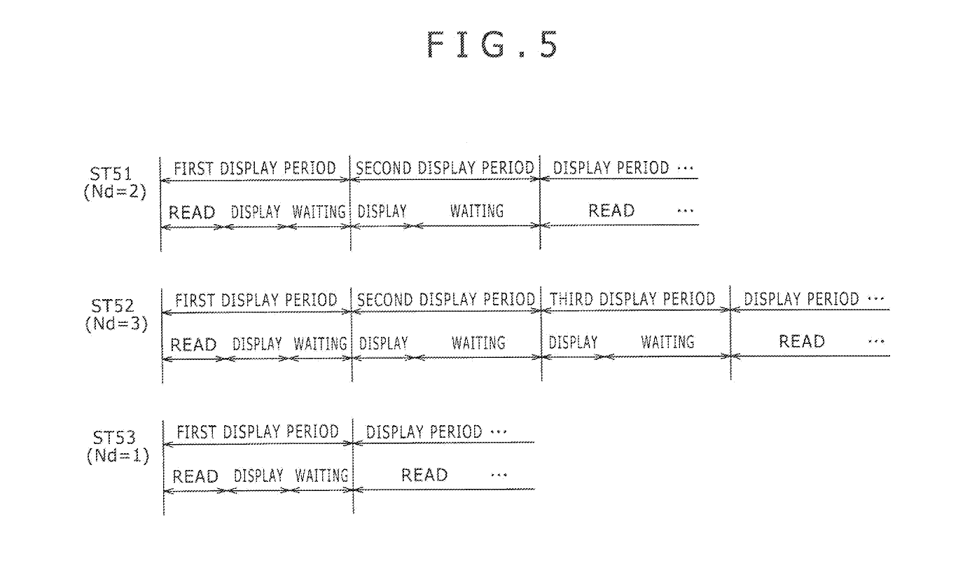

FIG. 5 is a diagram showing the control for displaying the image information. When the kind of read Position represents either the normal position or the buffering position, as shown in a state ST51 of FIG. 5, the display control portion 34 outputs the image information to the display portion 35 and waits for coming of the second display period with the first display period. When the second display period has come, the display control portion 34 outputs the same image information to the display portion 35 again and waits for the coming of the third period. Therefore, the image corresponding to the same image information is repetitively displayed on the display portion 35 with the two display period.

When the kind of read position represents the negative adjustment portion, as shown in a state ST52 of FIG. 5, the display control portion 34 outputs the image information to the display portion 35 with the first display period. When the second period has come, the display control portion 34 outputs the same image information to the display portion 35 again. When the third display period has come, the display control portion 34 further outputs the same image information to the display portion 35 again. Therefore, the image corresponding to the same image information is repetitively displayed on the display portion 35 with the three display periods. When the kind of read position represents the positive adjustment portion, as shown in a state ST53 of FIG. 5, the display control portion 34 outputs the image information to the display portion 35 with the first display period. Therefore, the image corresponding to the same image information is displayed on the display portion 35 with the one display period.

When the display control portion 34 displays the image corresponding to the image information in the number, Nd, of times of the display corresponding to the read position of the image information, the display control portion 34 increments the contents of the read counter Cr by 1 (Step S21). In this case, for example, the contents of the read counter Cr are updated to Cr=6. Also, the operation of the display control portion 34 returns back to the processing in Step S12, and the display control portion 34 instructs the buffer control portion 33 to read out the image information specified by the read counter Cr. In this case, the buffer control portion 33 is instructed to read out the image information 6 specified by the read counter Cr=26.

When the user requests the control portion 37 to end the image display by using the manipulation portion 36 in the middle of the ten pieces of processing Step S12 to S21 described above, the control portion 37 instructs the display control portion 34 to end the image display. In addition, the control portion 37 requests the server 2 to end the delivery of the image display through the transmission IF 31.

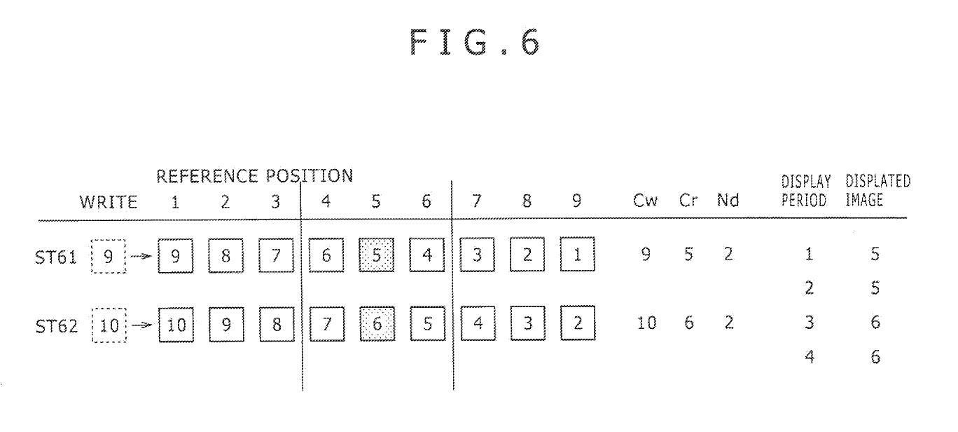

FIGS. 6 to 8 are respectively diagrams showing a method of adjusting the number, Nd, of times of the display of the image corresponding to the image information. FIG. 6 shows the case where the interval of the reception of the image information, and the period of the delivery of the image information agree with each other. At a time point at which the start of the image display is instructed, the nine pieces of image information 9 to 1 are accumulated in the reference positions 1 to 9, respectively, and the contents of the write counter Cw are set as Cw=9. When the reading of the image information 5 is instructed by using the contents of the read counter Cr=5, since the contents of the write counter Cw are Cw=9, the image information 5 is read out from the reference position 5, in a word, from the normal position. Therefore, the number, Nd, of times of the display of the image corresponding to the image information 5 is set as Nd=2, and the image corresponding to the image information 5 is repetitively displayed on the display portion 35 with the first and second display periods (a state ST61).

Before the coming of the third display period, the image information 10 is newly written to the buffer 32, and the contents of the write counter Cw are set as Cw=10. When the reading of the image information 6 is instructed by using the contents of the read counter Cr=6, since the contents of the write counter Cw are Cw=10, the image information 6 is read out from the reference position 6, in a word, from the normal position. Therefore, the number, Nd, of times of the display of the image corresponding to the image information 6 is set as Nd=2, and the image corresponding to the image information 6 is repetitively displayed with the third and fourth display periods (a state ST62).

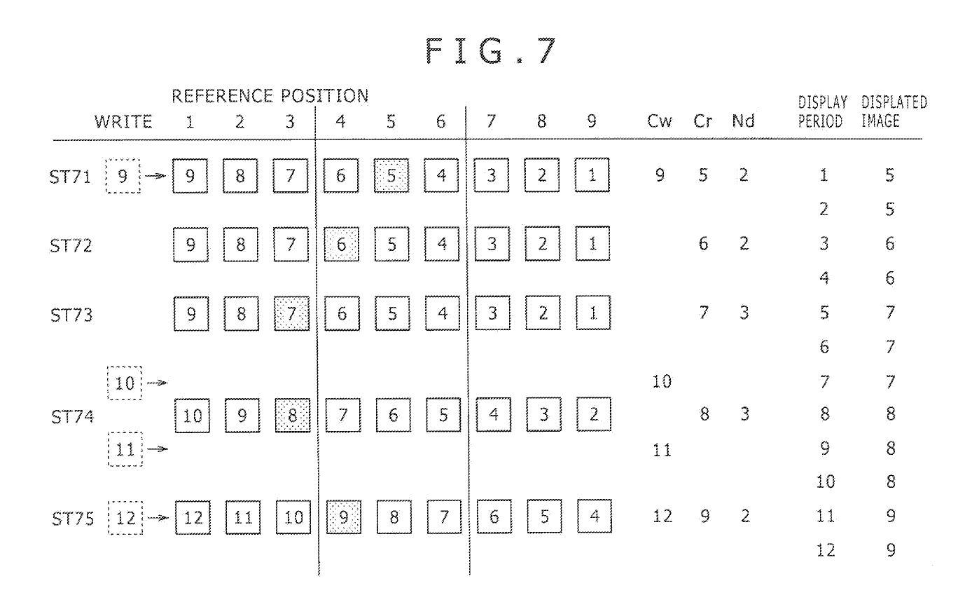

FIG. 7 shows the case where the interval of the reception of the image information is longer than the period of the delivery of the image information. At a time point at which the start of the image display is instructed, the contents of the write counter Cw are set as Cw=9. Therefore, similarly to the case of the state ST61 shown in FIG. 6, the image corresponding to the image information 5 is repetitively displayed with the first and second display periods (a state ST71).

Also, when the interval of the reception of the image information is longer than the period of the delivery of the image information, before the third display period has come, the image information 10 is not newly written, and the contents of the write counter Cw are held set as Cw=9. When the reading of the image information 6 is instructed by using the contents of the read counter Cr=6, since the contents of the write counter Cw are Cw=9, the image information 6 is read out from the reference position 4, in a word, from the buffering position. Therefore, the number, Nd, of times of the display of the image corresponding to the image information 5 is set as Nd=2, and the image corresponding to the image information 5 is repetitively displayed with the third and fourth display periods (a state ST72).

Before the coming of the fifth display period, the image information 10 is not yet newly written to the buffer 32, and thus the contents of the write counter Cw are held set as Cw=9. When the reading of the image information 7 is instructed by using the contents of the read counter Cr=7, since the contents of the write counter Cw are Cw=9, the image information 7 is read out from the reference position 3, in a word, from the negative adjustment position. Therefore, the number, Nd, of times of the display of the image corresponding to the image information 7 is set as Nd=3, and the image corresponding to the image information 7 is repetitively displayed with the fifth to seventh display periods (a state ST73).

Also, the interval of the reception of the image information agrees with the period of the delivery of the image information right after the sixth display period. Then, before the coming of the eighth display period, the image information 10 is newly written to the buffer 32, and thus the contents of the write counter Cw are set as Cw=10. When the reading of the image information 8 is instructed by using the contents of the read counter Cr=8, since the contents of the write counter Cw are Cw=10, the image information 8 is read out from the reference position 3, in a word, from the negative adjustment position. Therefore, the number, Nd, of times of the display of the image corresponding to the image information 8 is set as Nd=3, and the image corresponding to the image information 8 is repetitively displayed with the eighth to tenth display periods (a state ST74).

Before the coming of the eleventh display period, the two pieces of image information 11 and 12 are newly written to the buffer 32, and thus the contents of the write counter Cw are set as Cw=12. When the reading of the image information 9 is instructed by using the contents of the read counter Cr=9, since the contents of the write counter Cw are Cw=12, the image information 9 is read out from the reference position 4, in a word, from the buffering position. Therefore, the number, Nd, of times of the display of the image corresponding to the image information 9 is set as Nd=2, and the image corresponding to the image information 9 is repetitively displayed with the eleventh and twelfth display periods (a state ST75).

As a result, even when the interval of the reception of the image information is longer than the period of the delivery of the image information, the number, Nd, of times of the display of the image corresponding to the same image information is increased, which results in that a time difference between the interval of the reception of the image information and the period of the delivery of the image information can be shortened, and thus the image display can be controlled within the range of the ability of the buffer 32. As a result, even when the reception of the image information is late, the image corresponding to the image information can be smoothly displayed, and thus the reduction of the image quality can be suppressed.

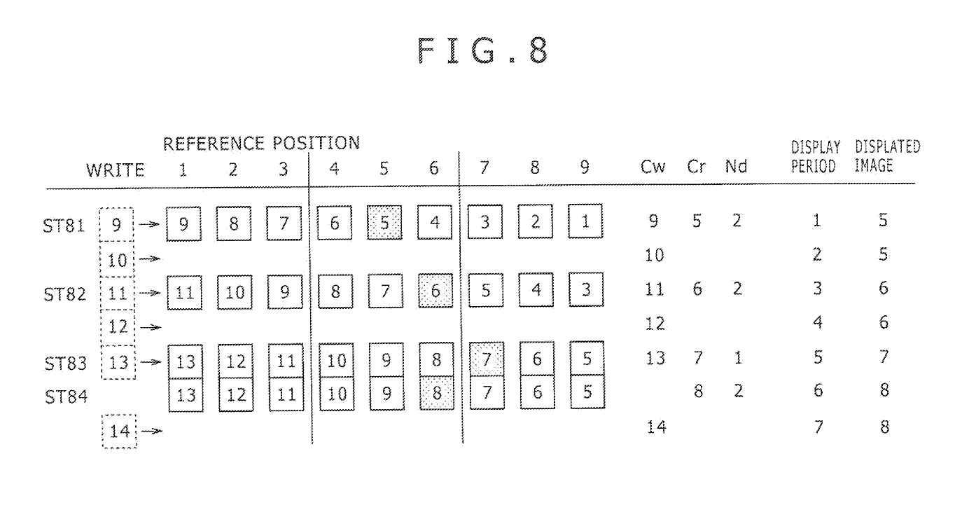

FIG. 8 shows the case where the interval of the reception of the image information is shorter than the period of the delivery of the image information. At a time point at which the start of the image display is instructed, the contents of the write counter Cw are set as Cw=9. Therefore, similarly to the case of the state ST61 shown in FIG. 6, the image corresponding to the image information 5 is repetitively displayed with the first and second display periods (a state ST81).

Also, when the interval of the reception of the image information is shorter than the period of the delivery of the image information, before the third display period has come, the two pieces of the image information 10 and 11 are newly written to the buffer 32, and the contents of the write counter Cw are set as Cw 11. When the reading of the image information 6 is instructed by using the contents of the read counter Cr=6, since the contents of the write counter Cw are Cw=11, the image information 6 is read out from the reference position 6, in a word, from the buffering position. Therefore, the number, Nd, of times of the display of the image corresponding to the image information 6 is set as Nd=2, and the image corresponding to the image information 6 is repetitively displayed with the third and fourth display periods (a state ST82).

Before the coming of the fifth display period, the two pieces of image information 12 and 13 are newly written to the buffer 32, and the contents of the write counter Cw are set as Cw=13. When the reading of the image information 7 is instructed by using the contents of the read counter Cr=7, since the contents of the write counter Cw are Cw=13, the image information 7 is read out from the reference position 7, in a word, from the positive adjustment position. Therefore, the number, Nd, of times of the display of the image corresponding to the image information 7 is set as Nd=1, and thus the image corresponding to the image information 7 is displayed only with the fifth display period (a state ST83).

Also, the interval of the reception of the image information agrees with the period of the delivery of the image information right after the sixth display period. Then, before the coming of the fifth display period, the image information 14 is not newly written to the buffer 32, and thus the contents of the write counter Cw are held set as Cw=13. When the reading of the image information 8 is instructed by using the contents of the read counter Cr=8, since the contents of the write counter Cw are Cw=13, the image information 8 is read out from the reference position 6, in a word, from the buffering position. Therefore, the number, Nd, of times of the display of the image corresponding to the image information 8 is set as Nd=2, and thus the image corresponding to the image information 8 is repetitively displayed with the sixth and seventh display periods (a state ST84).

As a result, even when the interval of the reception of the image information is shorter than the period of the delivery of the image information, the number, Nd, of times of the display of the image corresponding to the same image information is reduced, which results in that a time difference between the interval of the reception of the image information and the period of the delivery of the image information can be shortened, and thus the image display can be controlled within the range of the ability of the buffer 32. As a result, even when the reception of the image information is early, the image corresponding to the image information can be smoothly displayed, and thus the reduction of the image quality can be suppressed.

### 3. Program

A program according to another embodiment of the present disclosure causes a computer to execute the image display method. The method includes: receiving the image information delivered from the camera 1 through the transmission path 4; accumulating the image information thus received in the buffer 32; writing the image information thus received to the buffer 32, and reading out the image information in the order of writing from the buffer 32; repetitively displaying the image corresponding to the image information thus read out with one or more display periods set in accordance with the delivery period and the display period of the image information; and increasing the number, Nd, of times of the display period with which the image corresponding to the image information is repetitively displayed on the display portion 35 when the reception interval of the image information is longer than the delivery period of the image information in accordance with the communication situation of the transmission path 4 and decreasing the number, Nd, of times of the display period with which the image corresponding to the image information is repetitively displayed on the display portion 35 when the reception interval of the image information is shorter than the delivery period of the image information in accordance with the communication situation of the transmission path 4.

Although the embodiments of the present disclosure have been described so far with reference to the accompanying drawings, the present disclosure is by no means limited thereto. It is obvious that a person who has a normal knowledge in the technical field to which the present disclosure belongs hits upon various kinds of changes or modifications within the category of the technical ides disclosed in the appended claims. Also, is understood that the various kinds of changes or modifications naturally belong to the technical scope of the present disclosure.

The present disclosure contains subject matter related to that disclosed in Japanese Priority Patent Application JP 2010-265650 filed in the Japan Patent Office on Nov. 29, 2010, the entire content of which is hereby incorporated by reference.

What is claimed is:

1. An image display apparatus, comprising:
a receiving portion configured to receive image information delivered from a camera through a transmission path;
a buffer configured to accumulate therein the image information thus received;
a buffer control portion configured to write the image information thus received to said buffer, and read out the image information in an order of writing from said buffer;
a display portion configured to repetitively display thereon an image corresponding to the image information thus read out with one or more display periods set in accordance with a relationship between a delivery period and a display period of the image information; and
a display control portion configured to increase the number of times of the display period with which the image corresponding to the image information is repetitively displayed when a reception interval of the image information is longer than the delivery period of the image information depending on a communication situation of said transmission path and decrease the number of times of the display period with which the image corresponding to the image information is repetitively displayed when the reception interval of the image information is shorter than the delivery period of the image information depending on the communication situation of said transmission path.

2. The image display apparatus according to claim 1, wherein when a difference between the interval of the reception of the image information, and the period of the delivery of the image information exceeds a threshold value, said display control portion increases or decreased the number of times of the display period for the repetitive display of the image corresponding to the image information.

3. The image display apparatus according to claim 1, wherein either said buffer control portion or said display control portion specifies a position, on said buffer, from which the image information is to be read out, thereby comparing the interval of the reception of the image information, and the period of the delivery of the image information with each other.

4. The image display apparatus according to claim 3, wherein either said buffer control portion or said display control portion specifies a position, on said buffer, from which the image information is to be read out in accordance with a relationship between a sequence of the image information newly written to said buffer, and a sequence of the image information which is to be read out from said buffer.

5. An image display system, comprising:
a camera; and
an image display apparatus connected to said camera through a transmission path,
said image display apparatus including
a receiving portion configured to receive image information delivered from a camera through a transmission path,
a buffer configured to accumulate therein the image information thus received,
a buffer control portion configured to write the image information thus received to said buffer, and read out the image information in an order of writing from said buffer,
a display portion configured to repetitively display thereon an image corresponding to the image information thus read out with one or more display periods set in accordance with a relationship between a delivery period and a display period of the image information, and
a display control portion configured to increase the number of times of the display period with which the image corresponding to the image information is repetitively displayed when a reception interval of the image information is longer than the delivery period of the image information depending on a communication situation of said transmission path and decrease the number of times of the display period with which the image corresponding to the image information is repetitively displayed when the reception interval of the image information is shorter than the delivery period of the image information depending on the communication situation of said transmission path.

6. An image display method, comprising:
receiving image information delivered from a camera through a transmission path;
accumulating the image information thus received in a buffer;
writing the image information thus received to said buffer, and reading out the image information in an order of writing from said buffer;
repetitively displaying an image corresponding to the image information thus read out with one or more display periods set in accordance with a relationship between a delivery period and a display period of the image information; and
increasing the number of times of the display period with which the image corresponding to the image information is repetitively displayed when a reception interval of the image information is longer than the delivery period of the image information depending on a communication situation of said transmission path and decreasing the number of times of the display period with which the image corresponding to the image information is repetitively displayed when the reception interval of the image information is shorter than the delivery period of the image information depending on the communication situation of said transmission path.

7. A program causing a computer to execute an image display method comprising:
receiving image information delivered from a camera through a transmission path;
accumulating the image information thus received in a buffer;
writing the image information thus received to said buffer, and reading out the image information in an order of writing from said buffer;
repetitively displaying an image corresponding to the image information thus read out with one or more display periods set in accordance with a delivery period and a display period of the image information; and
increasing the number of times of the display period with which the image corresponding to the image information is repetitively displayed when a reception interval of the image information is longer than the delivery period of the image information depending on a communication situation of said transmission path and decreasing the number of times of the display period with which the image corresponding to the image information is repetitively displayed when the reception interval of the image information is shorter than the delivery period of the image information depending on the communication situation of said transmission path.
